(19) United States
(12) Patent Application Publication
(10) Pub. No.: US 2025/0379670 A1
(43) Pub. Date: Dec. 11, 2025

(54) CSI FEEDBACK BASED ON NETWORK-SIDE INTERFERENCE PREDICTION

(71) Applicant: QUALCOMM Incorporated, San Diego, CA (US)

(72) Inventors: Mohamed Fouad Ahmed MARZBAN, San Diego, CA (US); Tao LUO, San Diego, CA (US); Wooseok NAM, San Diego, CA (US)

(21) Appl. No.: 18/734,692

(22) Filed: Jun. 5, 2024

(51) Int. Cl. H04B 17/309; H04B 7/06; H04W 24/10

(52) U.S. Cl. CPC H04B 17/346; H04B 7/0626; H04W 24/10

(57) ABSTRACT

This disclosure provides systems, methods and apparatuses for reporting channel state feedback based on predicted interference on future resources. A user equipment may output an interference measurement report. A network entity may obtain the interference measurement report and output an indication of predicted interference on future resources, the interference predicted based on the interference measurement report. The UE may obtain the indication and may output a channel state feedback report based at least in part on the indication of the predicted interference.

### TECHNICAL FIELD

The present disclosure relates to wireless communications including channel state information (CSI) feedback based on network-side interference prediction.

### DESCRIPTION OF THE RELATED TECHNOLOGY

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (such as with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard.

### SUMMARY

The systems, methods and devices of this disclosure each have several innovative aspects, no single one of which is solely responsible for the desirable attributes disclosed herein.

In some aspects, the techniques described herein relate to an apparatus for wireless communication, including: one or more memories storing computer-executable instructions; and one or more processors configured to execute the computer-executable instructions, individually or in combination, to cause the apparatus to: output an interference measurement report for a user equipment (UE); obtain an indication of predicted interference on future resources, the interference predicted based on the interference measurement report; and output a channel state feedback report based at least in part on the indication.

In some aspects, the techniques described herein relate to an apparatus for wireless communication, including: one or more memories storing computer-executable instructions; and one or more processors coupled with the one or more memories and configured to execute the computer-executable instructions, individually or in combination, to cause the apparatus to: obtain an interference measurement report from a user equipment (UE); output an indication of predicted interference on future resources, the interference predicted based on the interference measurement report; and obtain a channel state feedback report based on the indication.

In some aspects, the techniques described herein relate to a method of wireless communication at a user equipment (UE), including: outputting an interference measurement report; obtaining an indication of predicted interference on future resources, the interference predicted based on the interference measurement report; and outputting a channel state feedback report based at least in part on the indication of the predicted interference.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 is a diagram illustrating an example of a wireless communications system including an access network.

FIG. 2A is a diagram illustrating an example of a first frame.

FIG. 2B is a diagram illustrating an example of DL channels within a subframe.

FIG. 2C is a diagram illustrating an example of a second frame.

FIG. 2D is a diagram illustrating an example of a subframe.

FIG. 3 is a diagram illustrating an example of a base station (BS) and user equipment (UE) in an access network.

FIG. 4 is a diagram illustrating an example disaggregated base station architecture.

FIG. 5 is a diagram of an example scenario for channel state information (CSI) feedback

based on network-side interference prediction.

FIG. 6 is a message diagram showing various messages to facilitate CSI feedback based on network-side interference prediction.

FIG. 7 is a resource diagram showing resources for CSI feedback based on network-side interference prediction.

FIG. 8 is a conceptual data flow diagram illustrating the data flow between different means/components in an example network entity including an interference component.

FIG. 9 is a conceptual data flow diagram illustrating the data flow between different means/components in an example UE including a channel state feedback component.

FIG. 10 is a flowchart of an example method for a wireless node such as a UE to report channel state feedback based on predicted interference.

FIG. 11 is a flowchart of an example method for a wireless node such as a network entity to receive channel state feedback based on predicted interference.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. Some of the examples in this disclosure are based on wireless and wired local area network (LAN) communication according to the Institute of Electrical and Electronics Engineers (IEEE) 802.11 wireless standards, the IEEE 802.3 Ethernet standards, and the IEEE 1901 Powerline communication (PLC) standards. However, the described implementations may be implemented in any device, system or network that is capable of transmitting and receiving RF signals according to any of the wireless communication standards, including any of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IOT) network, such as a system utilizing 3G, 4G or 5G, or further implementations thereof, technology.

In wireless communications, interference variations can significantly impact system performance. Although a user equipment may perform interference measurements and provide feedback to the network, interference variation reduces the usefulness of such measurements. For example, there is typically a delay between the interference measurements reported by the UE and the actual use of these measurements in scheduling the UE. With interference variation, there may be a mismatch between the scheduling and the actual interference. For example, if high interference is measured, additional resources may be allocated to compensate, but the additional resources may not be necessary if the actual interference is less than the measured interference. Conversely, if low interference is measured, but high interference occurs during the actual transmission, the UE may be unable to decode the transmission.

Many configuration parameters at the neighboring cells have impacts on the temporal, frequency, and spatial correlation of inter-cell interference observed at the UEs. For example, scheduling behavior may include: scheduling type (e.g., proportional fair, round robin) or scheduling granularity (e.g., mini-slot, slot, multi-slot). Other configuration parameters include the number of active UEs, traffic type at the neighboring cells, loading/resource utilization (RU), and beam management. Further, channel variations (between interfering cells and the UE) acts as another source of interference variation.

In an aspect, by observing the interference patterns on previous resources, the UE or a network entity such as a gNB can predict the interference on future resources and allow advanced scheduling strategies. For example, if some resources are expected to experience high interference, those resource can be excluded from resource allocation. For usable resources, advanced scheduling strategies may include adapting the modulation and coding scheme (MCS) and/or rank based on the predicted interference, estimating a time/frequency correlation of the interference to be used in demodulation, or adapting a reference signal design based on the predicted interference.

Due to the number of factors that influence interference, an artificial intelligence (AI) or machine-learning (ML) based approach to interference prediction is advantageous. It is difficult to derive a conventional analytical model for the interference prediction. An AI/ML approach for interference prediction can learn the interference variation patterns from previous resources to allow interference predictions on future resources. Further AI/ML approaches are demonstrating improved performance in other areas of wireless communications such as beam predication and compression of channel state information.

Interference can conceivably be predicted by either a UE or a network entity. The network typically has access to more data (by collecting data from many UEs) which allows the network entity to train a more robust ML algorithm. Further, the network can directly utilize the predicted interference information to allow advanced scheduling and link adaptation techniques. There is also less power restriction at the network entity. Hence, inference at the network entity allows UE power saving. Although the UE has greater access to interference measurements and network-side interference prediction may include overhead of transmitting the interference measurements, network-side interference prediction reduces the overhead of the UE reporting the predicted interference information.

In an aspect, the present disclosure provides channel state information feedback based on network-side interference prediction. The UE measures interference and provides an interference measurement report to the network. The network uses the interference measurement report to predict interference on future resources. The network provides an indication of the predicted interference to the UE. The UE may then generate a channel state feedback report based at least in part on the indication.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. The processor may include an interface or be coupled to an interface that can obtain or output signals. The processor may obtain signals via the interface and output signals via the interface. In some implementations, the interface may be a printed circuit board (PCB) transmission line. In some other implementations, the interface may include a wireless transmitter, a wireless transceiver, or a combination thereof. For example, the interface may include a radio frequency (RF) transceiver which can be implemented to receive or transmit signals, or both. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example implementations, the functions described may be implemented in hardware, software, or any combination thereof. If implemented in software, the functions may be stored on or encoded as one or more instructions or code on a computer-readable medium. Computer-readable media includes computer storage media, which may be referred to as non-transitory computer-readable media. Non-transitory computer-readable media may exclude transitory signals. Storage media may be any available media that can be accessed by a computer. By way of example, and not limitation, such computer-readable media can include a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

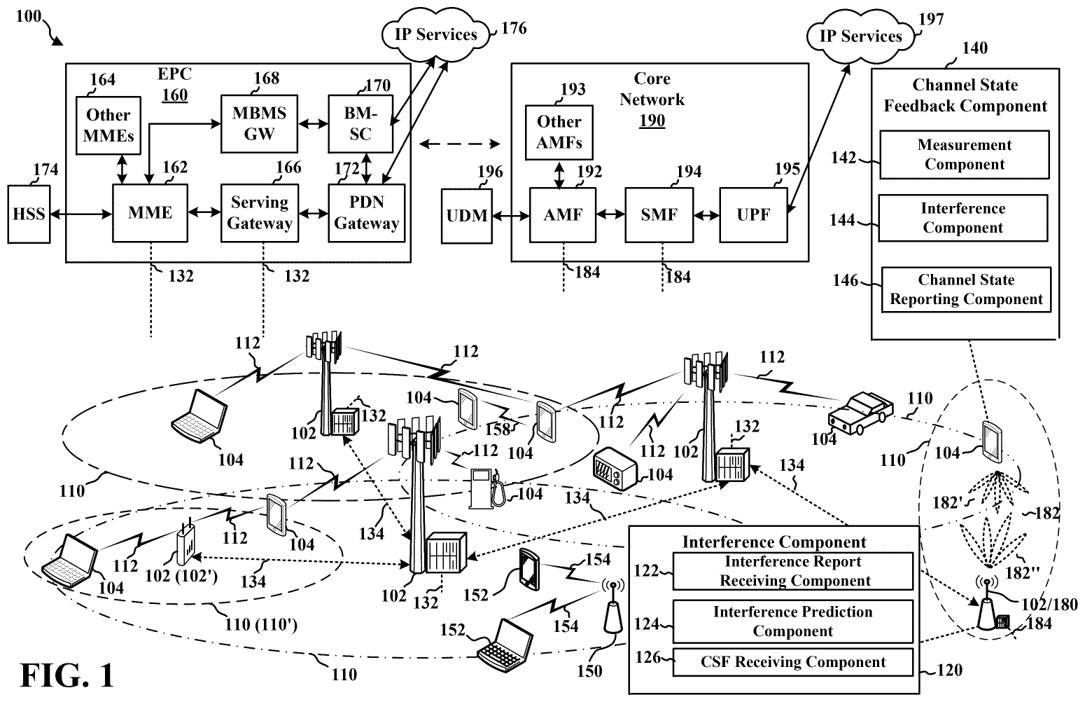

FIG. 1 is a diagram illustrating an example of a wireless communications system and an access network 100. The wireless communications system (also referred to as a wireless wide area network (WWAN)) includes wireless nodes such as base stations 102 and UEs 104, an Evolved Packet Core (EPC) 160, and another core network 190 (such as a 5G Core (5GC)). The base stations 102 may include macrocells (high power cellular base station) or small cells (low power cellular base station). The macrocells include base stations. The small cells include femtocells, picocells, and microcells. The small cells include femtocells, picocells, and microcells. The base stations 102 can be configured in a Disaggregated RAN (D-RAN) or Open RAN (O-RAN) architecture, where functionality is split between multiple units such as a central unit (CU), one or more distributed units (DUs), or a radio unit (RU). Such architectures may be configured to utilize a protocol stack that is logically split between one or more units (such as one or more CUs and one or more DUs). In some aspects, the CUs may be implemented within an edge RAN node, and in some aspects, one or more DUs may be co-located with a CU, or may be geographically distributed throughout one or multiple RAN nodes. The DUs may be implemented to communicate with one or more RUs.

In some implementations, one or more wireless nodes such as the UEs 104 include a channel state feedback component 140 configured to provide channel state feedback based at least in part on predicted interference to future resources. The channel state feedback component 140 includes a measurement component 142, an interference component 144, and a channel state reporting component 146. The measurement component 142 is configured to output an interference measurement report for the UE 104. The interference component 144 is configured to obtain an indication of predicted interference on future resources, the interference predicted based on the interference measurement report. The channel state reporting component 146 is configured to output a channel state feedback report based at least in part on the indication. In some implementations, the wireless node includes a transceiver configured to transmit the interference measurement report and/or the channel state feedback report.

In some implementations, one or more of the network entities such as a base station 102 include an interference component 120 configured to predict interference to future resources and receive a channel state feedback report based on the predicted interference for those future resources. The interference component 120 includes an interference report receiving interference report receiving component 122, an interference prediction component 124, and a channel state feedback (CSF) receiving component 126. The interference report receiving component 122 is configured to obtain an interference measurement report from a UE 104. The interference prediction component 124 is configured to output an indication of predicted interference on future resources, the interference predicted based on the interference measurement report. The CSF receiving component 126 is configured to obtain a channel state feedback report based on the indication.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (such as S1 interface), which may be wired or wireless. The base stations 102 configured for 5G NR (collectively referred to as Next Generation RAN (NG-RAN)) may interface with core network 190 through second backhaul links 184, which may be wired or wireless. In addition to other functions, the base stations 102 may perform one or more of the following functions: transfer of user data, radio channel ciphering and deciphering, integrity protection, header compression, mobility control functions (such as handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (such as through the EPC 160 or core network 190) with each other over third backhaul links 134 (such as X2 interface). The third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network also may include Home Evolved Node Bs (eNBs) (HeNBs), which may provide service to a restricted group known as a closed subscriber group (CSG). The communication links 112 between the base stations 102 and the UEs 104 may include UL (also referred to as reverse link) transmissions from a UE 104 to a base station 102 or DL (also referred to as forward link) transmissions from a base station 102 to a UE 104. The communication links 112 may use multiple-input and multiple-output (MIMO) antenna technology, including spatial multiplexing, beamforming, or transmit diversity. The communication links may be through one or more carriers. The base stations 102/UEs 104 may use spectrum up to Y MHz (such as 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (such as more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to or increase capacity of the access network.

A base station 102, whether a small cell 102′ or a large cell (such as macro base station), may include an eNB, gNodeB (gNB), or other type of base station. Some base stations, such as gNB 180 may operate in one or more frequency bands within the electromagnetic spectrum.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” (mmW) band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band. Communications using the mmW radio frequency band have extremely high path loss and a short range. The mmW base station 180 may utilize beamforming 182 with the UE 104 to compensate for the path loss and short range.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, or other IP services.

The base station may include or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (such as a MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (such as a parking meter, gas pump, toaster, vehicles, heart monitor, etc.). The UE 104 also may be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the following description may be focused on 5G NR, the concepts described herein may be applicable to other similar areas, such as LTE, LTE-A, CDMA, GSM, and other wireless technologies including future 6G technologies.

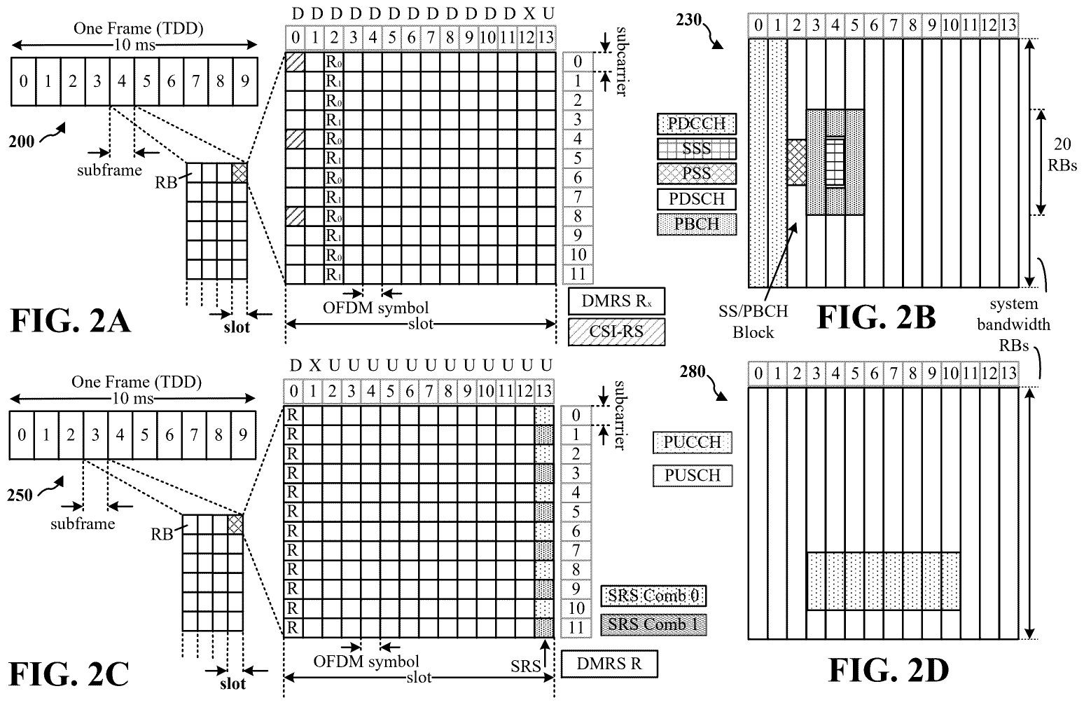

FIG. 2A is a diagram 200 illustrating an example of a first frame. FIG. 2B is a diagram 230 illustrating an example of DL channels within a subframe. FIG. 2C is a diagram 250 illustrating an example of a second frame. FIG. 2D is a diagram 280 illustrating an example of a subframe. The 5G NR frame structure may be FDD in which for a particular set of subcarriers (carrier system bandwidth), subframes within the set of subcarriers are dedicated for either DL or UL, or may be TDD in which for a particular set of subcarriers (carrier system bandwidth), subframes within the set of subcarriers are dedicated for both DL and UL. A subset of the total cell bandwidth of a cell is referred to as a Bandwidth Part (BWP) and bandwidth adaptation is achieved by configuring the UE with BWP(s) and telling the UE which of the configured BWPs is currently the active one. In an aspect, a narrow bandwidth part (NBWP) refers to a BWP having a bandwidth less than or equal to a maximum configurable bandwidth of a BWP. The bandwidth of the NBWP is less than the carrier system bandwidth.

In the examples provided by FIGS. 2A, 2C, the 5G NR frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure or different channels. A frame (10 milliseconds (ms)) may be divided into 10 equally sized subframes (1 ms). Each subframe may include one or more time slots. Subframes also may include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 microseconds (μs).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DMRS) (indicated as Rₓ for one particular configuration, where 100x is the port number, but other DM-RS configurations are possible) and channel state information reference signals (CSI-RS) for channel estimation at the UE. The RS also may include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A primary synchronization signal (PSS) may be within symbol 2 of particular subframes of a frame. The PSS is used by a UE 104 to determine subframe/symbol timing and a L1 identity. A secondary synchronization signal (SSS) may be within symbol 4 of particular subframes of a frame. The SSS is used by a UE to determine a L1 cell identity group number and radio frame timing. Based on the L1 identity and the L1 cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), or UCI.

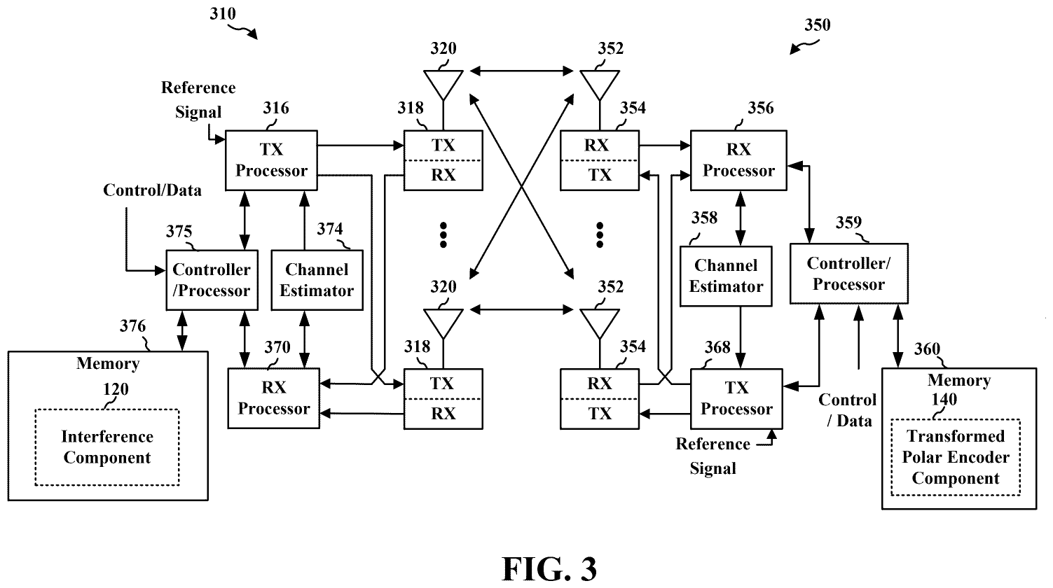

FIG. 3 is a diagram of an example of a base station 310 and a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (such as MIB, SIBs), RRC connection control (such as RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (such as binary phase-shift keying (BPSK), quadrature phase-shift keying (QPSK), M-phase-shift keying (M-PSK), M-quadrature amplitude modulation (M-QAM)). The coded and modulated symbols may be split into parallel streams. Each stream may be mapped to an OFDM subcarrier, multiplexed with a reference signal (such as a pilot) in the time or frequency domain, and combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal or channel condition feedback transmitted by the UE 350. Each spatial stream may be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are decoded and deinterleaved to recover the data and control signals that were originally transmitted by the base station 310 on the physical channel. The data and control signals are provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK or NACK protocol to support HARQ operations.

Similar to the functionality described in connection with the DL transmission by the base station 310, the controller/processor 359 provides RRC layer functionality associated with system information (such as MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK or NACK protocol to support HARQ operations.

At least one of the TX processor 368, the RX processor 356, and the controller/processor 359 may be configured to perform aspects in connection with the channel state feedback component 140 of FIG. 1. For example, the memory 360 may include executable instructions defining the channel state feedback component 140. The TX processor 368, the RX processor 356, and/or the controller/processor 359 may be configured to execute the channel state feedback component 140.

At least one of the TX processor 316, the RX processor 370, and the controller/processor 375 may be configured to perform aspects in connection with the interference component 120 of FIG. 1. For example, the memory 376 may include executable instructions defining the interference component 120. The TX processor 316, the RX processor 370, and/or the controller/processor 375 may be configured to execute the interference component 120.

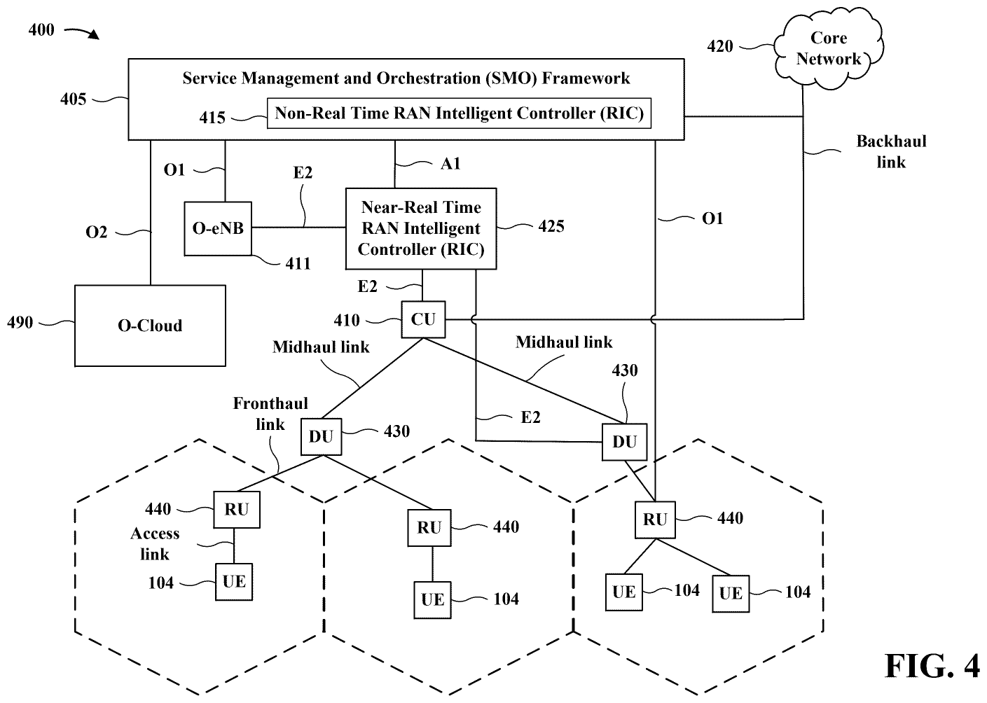

FIG. 4 is a diagram illustrating an example disaggregated base station 400 architecture. The disaggregated base station 400 architecture may include one or more central units (CUs) 410 that can communicate directly with a core network 420 via a backhaul link, or indirectly with the core network 420 through one or more disaggregated base station units (such as a Near-Real Time (Near-RT) RAN Intelligent Controller (RIC) 425 via an E2 link, or a Non-Real Time (Non-RT) RIC 415 associated with a Service Management and Orchestration (SMO) Framework 405, or both). A CU 410 may communicate with one or more distributed units (DUs) 430 via respective midhaul links, such as an F1 interface. The DUs 430 may communicate with one or more radio units (RUs) 440 via respective fronthaul links. The RUs 440 may communicate with respective UEs 104 via one or more radio frequency (RF) access links. In some implementations, the UE 104 may be simultaneously served by multiple RUs 440.

Each of the units, i.e., the CUs 410, the DUs 430, the RUs 440, as well as the Near-RT RICs 425, the Non-RT RICs 415 and the SMO Framework 405, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 410 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 410. The CU 410 may be configured to handle user plane functionality (i.e., Central Unit-User Plane (CU-UP)), control plane functionality (i.e., Central Unit-Control Plane (CU-CP)), or a combination thereof. In some implementations, the CU 410 can be logically split into one or more CU-UP units and one or more CU-CP units. The CU-UP unit can communicate bidirectionally with the CU-CP unit via an interface, such as the E1 interface when implemented in an O-RAN configuration. The CU 410 can be implemented to communicate with the DU 430, as necessary, for network control and signaling.

The DU 430 may correspond to a logical unit that includes one or more base station functions to control the operation of one or more RUs 440. In some aspects, the DU 430 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 430 may further host one or more low PHY layers. Each layer (or module) can be implemented with an interface configured to communicate signals with other layers (and modules) hosted by the DU 430, or with the control functions hosted by the CU 410.

Lower-layer functionality can be implemented by one or more RUs 440. In some deployments, an RU 440, controlled by a DU 430, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 440 can be implemented to handle over the air (OTA) communication with one or more UEs 104. In some implementations, real-time and non-real-time aspects of control and user plane communication with the RU(s) 440 can be controlled by the corresponding DU 430. In some scenarios, this configuration can enable the DU(s) 430 and the CU 410 to be implemented in a cloud-based RAN architecture, such as a vRAN architecture.

The SMO Framework 405 may be configured to support RAN deployment and provisioning of non-virtualized and virtualized network elements. For non-virtualized network elements, the SMO Framework 405 may be configured to support the deployment of dedicated physical resources for RAN coverage requirements which may be managed via an operations and maintenance interface (such as an O1 interface). For virtualized network elements, the SMO Framework 405 may be configured to interact with a cloud computing platform (such as an open cloud (O-Cloud) 490) to perform network element life cycle management (such as to instantiate virtualized network elements) via a cloud computing platform interface (such as an O2 interface). Such virtualized network elements can include, but are not limited to, CUs 410, DUs 430, RUs 440 and Near-RT RICs 425. In some implementations, the SMO Framework 405 can communicate with a hardware aspect of a 4G RAN, such as an open eNB (O-eNB) 411, via an O1 interface. Additionally, in some implementations, the SMO Framework 405 can communicate directly with one or more RUs 440 via an O1 interface. The SMO Framework 405 also may include a Non-RT RIC 415 configured to support functionality of the SMO Framework 405.

The Non-RT RIC 415 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 425. The Non-RT RIC 415 may be coupled to or communicate with (such as via an A1 interface) the Near-RT RIC 425. The Near-RT RIC 425 may be configured to include a logical function that enables near-real-time control and optimization of RAN elements and resources via data collection and actions over an interface (such as via an E2 interface) connecting one or more CUs 410, one or more DUs 430, or both, as well as an O-eNB, with the Near-RT RIC 425.

In some implementations, to generate AI/ML models to be deployed in the Near-RT RIC 425, the Non-RT RIC 415 may receive parameters or external enrichment information from external servers. Such information may be utilized by the Near-RT RIC 425 and may be received at the SMO Framework 405 or the Non-RT RIC 415 from non-network data sources or from network functions. In some examples, the Non-RT RIC 415 or the Near-RT RIC 425 may be configured to tune RAN behavior or performance. For example, the Non-RT RIC 415 may monitor long-term trends and patterns for performance and employ AI/ML models to perform corrective actions through the SMO Framework 405 (such as reconfiguration via O1) or via creation of RAN management policies (such as A1 policies).

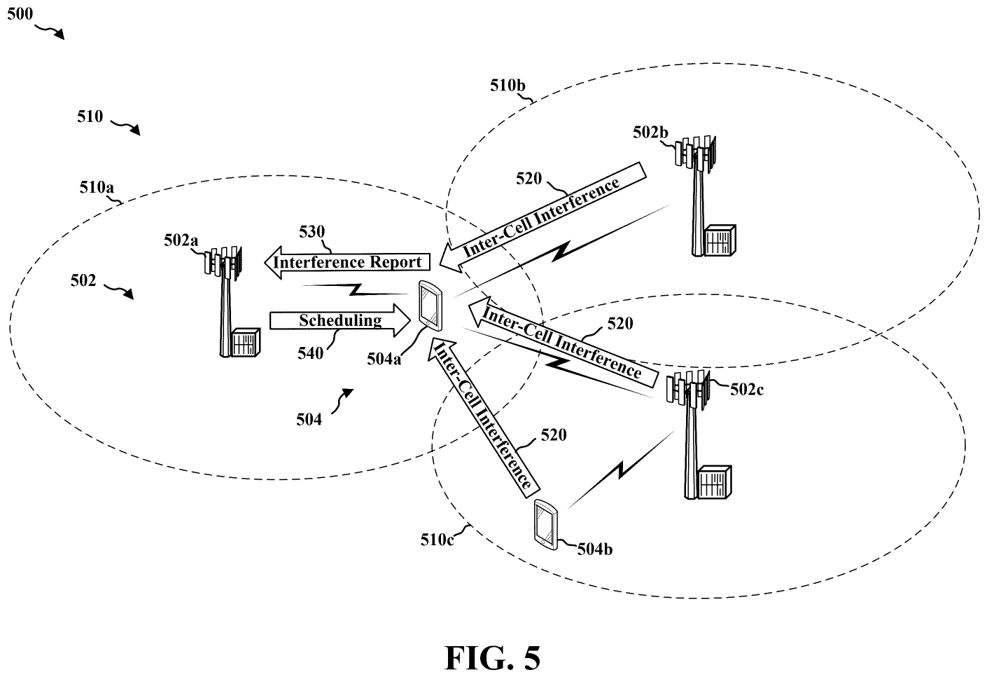

FIG. 5 is a diagram 500 of an example cellular deployment with inter-cell interference. In the illustrated example, there are three base stations 502 (e.g., base stations 502a, 502b, and 502c) each with a respective coverage area 510 (e.g., coverage areas 510a, 510b, and 510c) provide service to UEs 504. A UE 504a may be within coverage area 510a and connected to base station 502a. Signals transmitted by the other base stations 502b and 502c may act as inter-cell interference 520 towards the UE 504a. Similarly, uplink transmissions from a UE 504b that is connected to another cell may cause inter-cell interference 520.

One approach to mitigating inter-cell interference is for the UE 504a to transmit an interference report 530. The interference report 530 may include measurements of interference received on specified resources. The base station 502a may use the interference report 530 to schedule the UE 504a on resources that have less interference. For example, the base station 502a may transmit scheduling 540. In the case of interference variations, however, interference report 530 may not accurately indicate the interference on which the UE 504a is scheduled by scheduling 540.

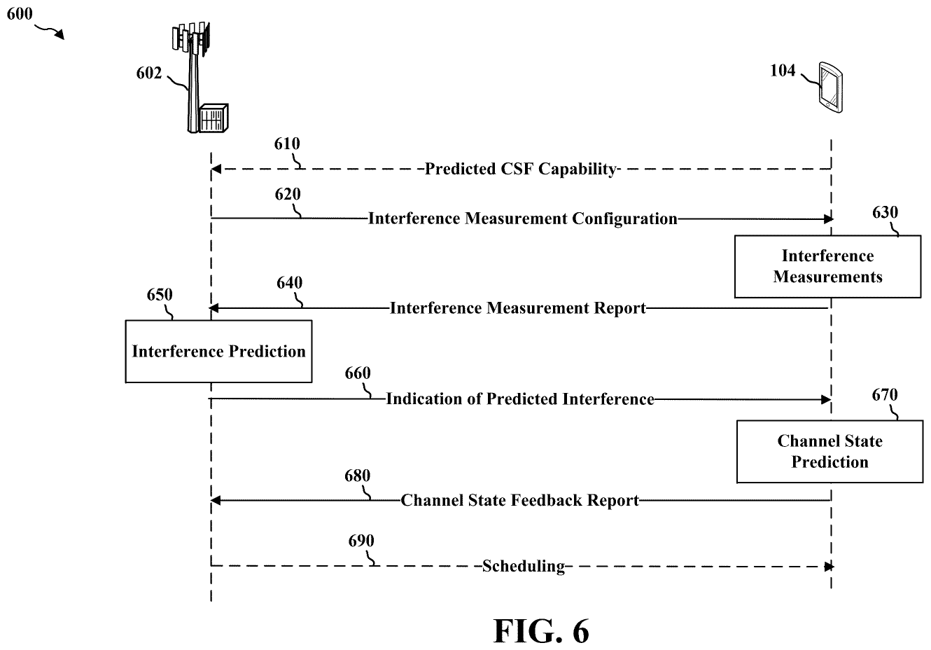

FIG. 6 is a message diagram 600 of example messages for a network entity 602 to schedule a UE 104 based on predicted interference. The network entity 602 may include a base station 102, or another network entity including the interference component 120. The use of predicted interference can account for variable interference patterns and current channel conditions of a UE.

In some implementations, the UE 104 may transmit a predicted channel state feedback (CSF) capability 610 that indicates a capability of the UE 104 to use predicted interference to predict channel state feedback for a future resource. In some implementations, the predicted CSF capability 610 may indicate a capability to transmit a new type of channel state information (CSI) report. Alternatively, the predicted CSF capability 610 may indicate that a conventional CSI report may be based on predicted interference.

The base station 102 may transmit an interference measurement configuration 620. The interference measurement configuration 620 may indicate resources on which the UE 104 should measure interference. In some implementations, the interference measurement configuration 620 may be a 5G measurement configuration and may use a combination of RRC messages, MAC-CEs, and DCIs to configure, activate, and select measurements. The interference measurement configuration 620 may include, for example, zero power CSI-RS resources on which the base station 102 transmits with zero power such that the UE 104 may measure interference from other devices. In some implementations, the interference measurement configuration 620 may configure the UE 104 to measure or report additional information such as grouping of interference measurements, timestamps of the interference measurements, a location of the UE, and/or measurement resources. For example, the measurements may be grouped over time or frequency to detect patterns of changes in the interference. The grouping information may include a start, an end, and a periodicity for a group of measurements. Timestamps and location of the UE may assist an ML model in predicting interference. The measurement resources may include CSI-RS, CSI-IM, DMRS, or PDSCH resources. The measurement resource may convey information on the beam, quasi-co-location (QCL), and/or precoder used in transmission. The measurement resource can affect the quality of the measured interference, so reporting of the measurement resource may assist with prediction of interference.

The UE 104 performs interference measurements 630, for example, based on the interference measurement configuration 620. The UE 104 transmits an interference measurement report 640 based on the interference measurements 630 and the interference measurement configuration 620. For example, the interference measurement report 640 can include a group of measurements and may indicates: one or more measurement resources used to measure the group of measurements; or one or more timestamps for the measurements.

The network entity 602 performs interference prediction 650 based on the interference measurement report. In some implementations, interference prediction 650 uses a ML model to predict interference to the UE 104 on future resources. The ML model may be trained or tuned to the specific UE 104 based on one or more interference measurement reports. For example, the ML model may be a neural network trained to predict an interference level on a future resource. An input layer of the ML model may receive input from a most recent interference measurement report. The ML model may be tuned by comparing the predicted interference for future resources to the measured interference on those resources that is later reported by the UE 104.

The network entity 602 transmits an indication 660 of predicted interference based on the interference prediction 650. The indication 660 indicates predicted interference on future resources. For example, the predicted interference may be a level of interference that the UE 104 is expected to receive on the future resources. In some implementations, the indication 660 can include one or more of: a predicted interference power; a signal to interference plus noise ratio (SINR); or an interference plus noise correlation matrix (Rₙₙ). For example, the predicted interference may be represented as a value or a level. The level may be enumerated or quantized. For instance, example enumerated levels may be high, medium and low interference power. As an example of quantized levels, the interference power range can be divided into many classes that each have a q dBm resolution and the network entity 602 can report the predicted class for the future resource. In some implementations, the indication of predicted interference includes a vector of predicted interference values or levels associated with multiple resources in a time domain or a frequency domain. In some implementations, the indication 660 of predicted interference is associated with one or more transmit beams, one or more receive beams, or one or more combinations of a transmit beam and a receive beam. For example, the predicted interference may be represented as a vector of interference predictions for multiple resources in time (slots/symbols), frequency (sub-bands or RBs) or beams. For instance, if a UE 104 is to be scheduled on multiple slots in the future, the network entity 602 may indicate a vector of interference predictions for these slots. In some implementations, the indication of predicted interference includes a confidence level of the prediction. For example, the confidence level can include a statistical property of the predicted interference (e.g., standard deviation of the predicted interference power). The confidence level can be a predicted interference distribution across different interference classes.

The UE 104 performs channel state prediction 670. The channel state prediction 670 may include estimating one or more CSI report indicators based on the indication 660 and the predicted interference on the future resource. For example, the CSI report indicators may include one or more of: a channel quality indicator (CQI), a precoding matrix indicator (PMI), a rank indicator (RI), a channel state information reference signal resource indicator (CRI), a synchronization signal block resource indicator (SSBRI), or a layer indicator (LI). In some implementations, the UE 104 may predict the channel state of the future resource by substituting the predicted interference for the future resource for the measured interference in a calculation of the indicator. For instance, the CQI calculation may be based in part on a signal to interference plus noise (SINR) of the channel. The UE 104 may adjust a measured SINR based on the predicted interference associated with the future resource when calculating the CQI.

The UE 104 may transmit a channel state feedback report 680 based at least in part on the interference predicted based on the interference measurement report 640. The channel state feedback report 680 may also be referred to as a CSF report or CSI report. The channel state feedback report 680 may include the one or more indicators calculated based on the predicted interference. In some implementations, the channel state feedback report 680 is an aperiodic CSI report triggered by obtaining the indication 660 of the predicted interference. That is, the indication 660 may schedule the transmission of the channel state feedback report 680. In some implementations, the channel state feedback report 680 includes a flag that indicates that the channel state feedback report is based on the predicted interference. For instance, the channel state feedback report 680 may be a periodic CSI report with the flag set to indicate that the CSI report is based on predicted interference.

In some implementations, the network entity 602 may schedule the UE 104 based at least in part on the channel state feedback report 680. For instance, the network entity 602 may select resources, a modulation and coding scheme (MCS), a precoding matrix, or other transmission parameters based on the channel state feedback report 680. The selected resources may include the future resources for which the interference was predicted.

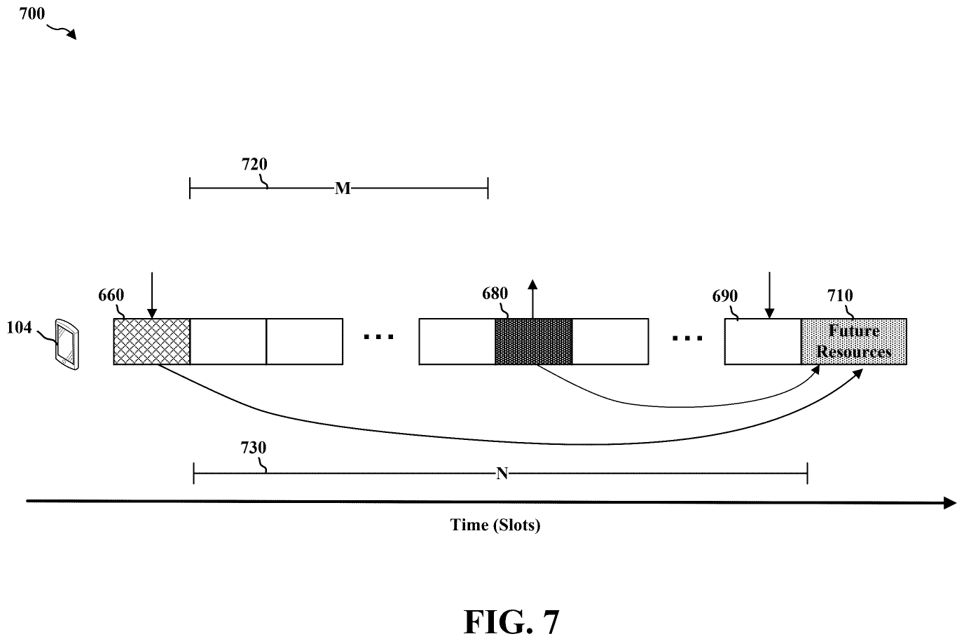

FIG. 7 is a resource diagram 700 showing resources for CSI feedback based on network-side interference prediction. The timing for the channel state feedback report 680 may be based on the indication 660. The indication 660 may implicitly or explicitly identify the future resources 710 for which interference is predicted. For example, the indication 660 may include a resource identifier with a value of N indicating a number of slots from the indication 660 to the future resource 710. Alternatively, the indication 660 may be map the indicated interference to future resources 710 based on a rule. For instance, one or more values of N 730 may be configured or defined in standards document and applied to a corresponding value or level of interference. In some implementations, the indication 660 may schedule the channel state feedback report 680, for example, as an aperiodic report. A value of M 720 may be configured or specified in a standards document to define a number of slots between the indication 660 and the channel state feedback report 680. Aperiodic scheduling of the channel state feedback report 680 based on the indication 660 may be configured via RRC and activated or deactivated using a MAC-CE. Scheduling 690 may be received before the future resources 710, for example, in a PDCCH of the same slot as the future resources 710.

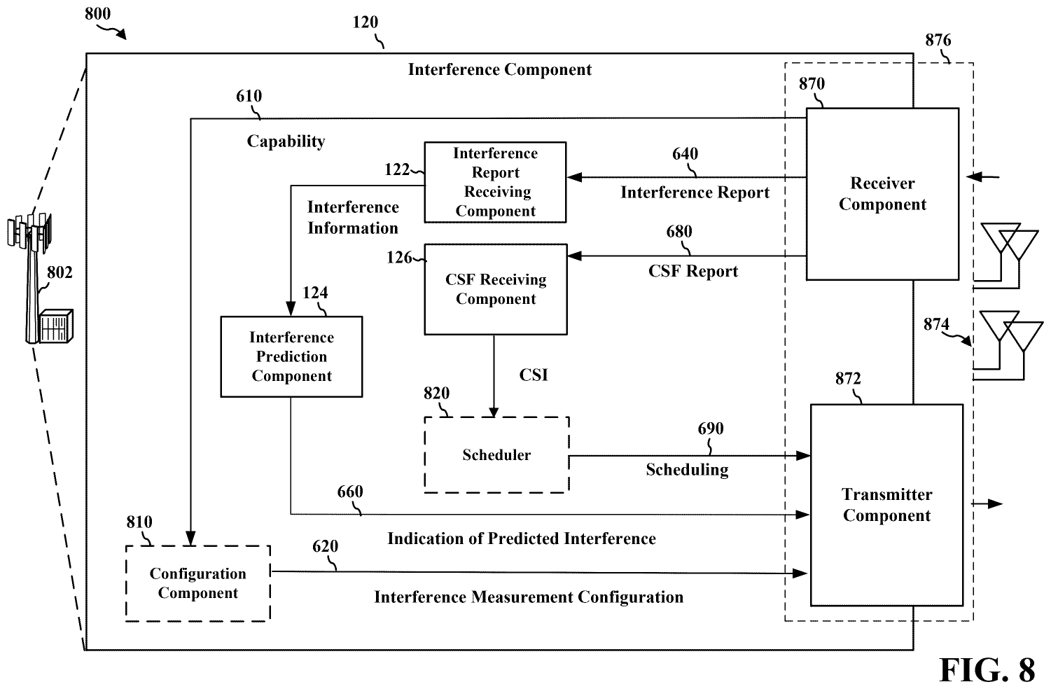

FIG. 8 is a conceptual data flow diagram 800 illustrating the data flow between different means/components in an example network entity 802 including an interference component 120. For example, the network entity 802 may be an example of a wireless node such as the base station 102 (FIG. 1) including the interference component 120. The interference component 120 may be implemented by the memory 376 and the TX processor 316, the RX processor 370, and/or the controller/processor 375 of FIG. 3. For example, the memory 376 may store executable instructions defining the interference component 120 and the TX processor 316, the RX processor 370, and/or the controller/processor 375 may execute the instructions.

The network entity 802 may include a receiver component 870, which may include, for example, a radio frequency (RF) receiver for receiving the signals described herein. The network entity 802 may include a transmitter component 872, which may include, for example, an RF transmitter for transmitting the signals described herein. The transmitter component 872 may output RF signals to one or more antennas 874. In an aspect, the network entity 802 and the transmitter component 872 may be co-located in a transceiver 876, which may correspond to the TX/RX 318 in FIG. 3.

As discussed with respect to FIG. 1, the interference component 120 may include the interference report receiving component 122, the interference prediction component 124, and the CSF receiving component 126. In some implementations, the interference component 120 may optionally include a configuration component 810 and/or a scheduler 820.

The receiver component 870 may receive signals from a UE 104. For example, the receiver component 870 may receive the predicted CSF capability 610, the interference measurement report 640, or the channel state feedback report 680. The receiver component 870 may output the predicted CSF capability 610 to the configuration component 810. The receiver component 870 may output the interference measurement report 640 to the component 122. The receiver component 870 may output the channel state feedback report 680 to the CSF receiving component 126.

The configuration component 810 may obtain the 610 via the receiver component 870. The configuration component 810 may output the interference measurement configuration 620 for transmission to the UE 104 in response to obtaining the predicted CSF capability 610.

The interference report receiving component 122 is configured to obtain the interference measurement report 640 from the UE 104 via the receiver component 870. The interference report receiving component 122 may provide interference information from one or more interference measurement reports 640 to the interference prediction component 124. In some implementations, the interference report receiving component 122 may format the interference information as a training set including the previously predicted interference corresponding to the measured interference such that the interference prediction component 124 may train or tune the ML model. In some implementations, the interference report receiving component 122 may format the interference information as an input vector such that the interference prediction component 124 may predict interference to future resources.

The interference prediction component 124 obtains the interference information from the interference report receiving component 122. The interference prediction component 124 is configured to output an indication 660 of predicted interference on future resources, the interference predicted based on the interference measurement report. For example, as discussed above, the interference prediction component 124 may include an ML model trained to predict the interference on future resources for the UE 104 based on the interference information. The interference prediction component 124 outputs the indication 660 for transmission to the UE 104 via the transmitter component 872.

The CSF receiving component 126 is configured to obtain a channel state feedback report based on the indication. For example, the CSF receiving component 126 may obtain the channel state feedback report 680 from the UE 104 via the receiver component 870. The channel state feedback report 680 may be based on predicted interference to future resources rather than actual measurements at the UE 104. The CSF receiving component 126 may output CSI indicators to the scheduler 820. The CSF receiving component 126 may provide an indication that the CSI indicators are predicted for the future resources.

The scheduler 820 is configured to schedule transmission to or from the UE 104. When the CSI indicators received from the CSF receiving component 126 are predicted for future resources, the scheduler 820 may use the CSI indicators to schedule the UE on the future resources. For example, the scheduler 820 may select a modulation and coding scheme (MCS) based on the predicted CQI for the future resources. In some implementations, the scheduler 820 may avoid scheduling the future resources or may schedule additional resources when the predicted CSI indicators indicate poor channel conditions. The scheduler 820 may output scheduling 690 for transmission to the UE 104 via the transmitter component 872.

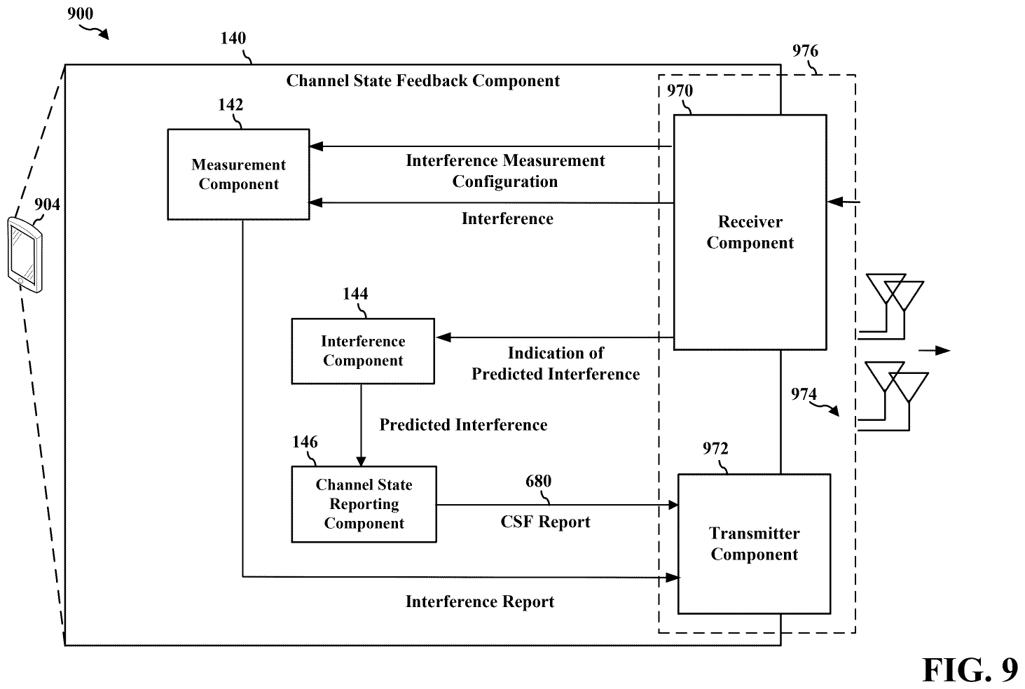

FIG. 9 is a conceptual data flow diagram 900 illustrating the data flow between different means/components in an example UE 904 including a channel state feedback component 140. For example, the UE 904 may be an example of a wireless node such as the UE 104 (FIG. 1) including the channel state feedback component 140. The channel state feedback component 140 may be implemented by the memory 360 and the TX processor 368, the RX processor 356, and/or the controller/processor 368 of FIG. 3. For example, the memory 360 may store executable instructions defining the channel state feedback component 140 and the TX processor 368, the RX processor 356, and/or the controller/processor 359 may execute the instructions.

The UE 904 may include a receiver component 970, which may include, for example, a radio frequency (RF) receiver for receiving the signals described herein. The UE 904 may include a transmitter component 972, which may include, for example, an RF transmitter for transmitting the signals described herein. The transmitter component 972 may output RF signals to one or more antennas 974. In an aspect, the UE 904 and the transmitter component 972 may be co-located in a transceiver 976, which may correspond to the TX/RX 354 in FIG. 3.

As discussed with respect to FIG. 1, the channel state feedback component 140 may include the measurement component 142, the interference component 144, and the channel state reporting component 146.

The receiver component 970 may receive signals from a UE 104. For example, the receiver component 970 may receive the interference measurement configuration 620, the indication 660, and the scheduling 690. In some implementations, the receiver component 970 may receive interference on resources configured for measuring interference. The receiver component 970 may output the interference measurement configuration 620 to the measurement component 142. The receiver component 970 may output the indication 660 to the interference component 144. The receiver component 970 may output the scheduling 690 to a decoder and/or modulator (not shown) for processing scheduled transmissions.

The measurement component 142 may obtain the interference measurement configuration 620 from the network entity 802 via the receiver component 970. The measurement component 142 may measure interference based on the interference measurement configuration 620. The measurement component 142 is configured to output an interference measurement report interference measurement report 640 for the UE 904. For example, the measurement component 142 may output the interference measurement report 640 for transmission to the network entity 802 via the transmitter component 972.

The interference component 144 is configured to obtain an indication of predicted interference on future resources, the interference predicted based on the interference measurement report. For example, the interference component 144 may obtain the indication 660 from the network entity 802 via the receiver component 970. The interference component 144 may output the predicted interference to the channel state reporting component 146.

The channel state reporting component 146 may obtain the predicted interference from the interference component 144. The channel state reporting component 146 is configured to output a channel state feedback report based at least in part on the indication. For example, the channel state reporting component 146 may calculate one or more channel state information indicators based on the predicted interference. The channel state reporting component 146 may output the channel state feedback report 680 for transmission to the network entity 802 via the transmitter component 972.

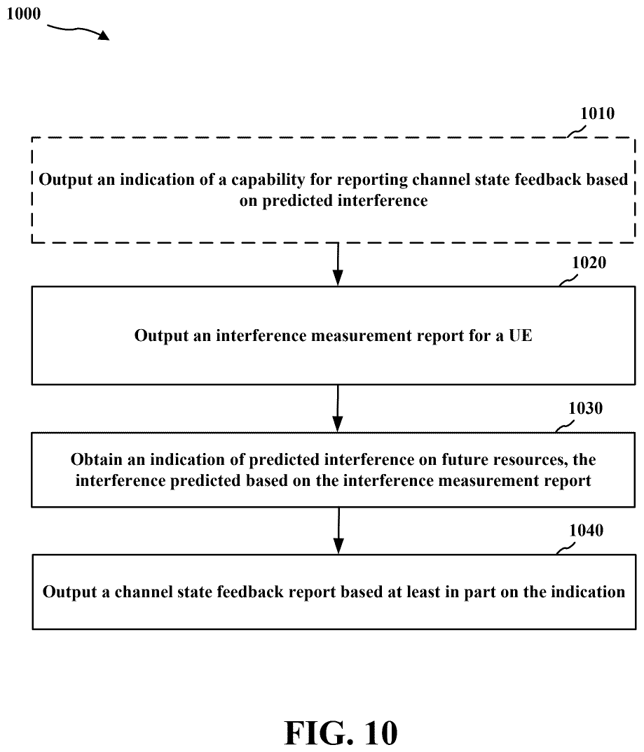

FIG. 10 is a flowchart of an example method 1000 for a wireless node such as a UE to report channel state feedback based on predicted interference. The method 1000 may be performed by a UE (such as the UE 104, which may include the memory 360 and which may be the entire UE 104 or a component of the UE 104 such as the channel state feedback component 140, TX processor 368, the RX processor 356, or the controller/processor 359). The method 1000 may be performed by the channel state feedback component 140 in communication with the interference component 120 at a network entity. Optional blocks are shown with dashed lines.

At block 1010, the method 1000 includes outputting an indication of a capability for reporting channel state feedback based on predicted interference. In some implementations, for example, the UE 104, the TX processor 368 or the controller/processor 359 may execute the channel state feedback component 140 or transmitter component 972 to output an indication of a capability for reporting channel state feedback based on predicted interference. Accordingly, the UE 104, the TX processor 368, or the controller/processor 359 executing the channel state feedback component 140 or the transmitter component 972 may provide means for outputting an indication of a capability for reporting channel state feedback based on predicted interference.

At block 1020, the method 1000 includes outputting an interference measurement report for a UE. In some implementations, for example, the UE 104, the TX processor 368 or the controller/processor 359 may execute the channel state feedback component 140 or the interference component 144 to output the interference measurement report 640 for a UE. In some implementations, the interference measurement report includes a group of measurements and indicates: one or more measurement resources used to measure the group of measurements; or one or more timestamps for the measurements. Accordingly, the UE 104, the TX processor 368, or the controller/processor 359 executing the channel state feedback component 140 or the interference component 144 may provide means for outputting an interference measurement report for a UE.

At block 1030, the method 1000 includes obtaining an indication of predicted interference on future resources, the interference predicted based on the interference measurement report. In some implementations, for example, the UE 104, the RX processor 356 or the controller/processor 359 may execute the channel state feedback component 140 or the channel state reporting component 146 to obtain an indication 660 of predicted interference on future resources 710, the interference predicted based on the interference measurement report 640. In some implementations, the indication of predicted interference includes one or more of: a predicted interference power; a SINR; or a matrix Rₙₙ. In some implementations, the indication of predicted interference is associated with one or more transmit beams, one or more receive beams, or one or more combinations of a transmit beam and a receive beam. In some implementations, the indication of predicted interference includes a vector of predicted interference levels associated with multiple resources in a time domain or a frequency domain. In some implementations, the indication of predicted interference includes a confidence level of the prediction. Accordingly, the UE 104, the RX processor 356, or the controller/processor 359 executing the channel state feedback component 140 or the channel state reporting component 146 may provide means for obtaining an indication of predicted interference on future resources, the interference predicted based on the interference measurement report.

At block 1040, the method 1000 includes outputting a channel state feedback report based at least in part on the indication. In some implementations, for example, the UE 104, the TX processor 368 or the controller/processor 359 may execute the channel state feedback component 140 or the channel state reporting component 146 to output a channel state feedback report 680 based at least in part on the indication 660. In some implementations, the channel state feedback report includes one or more indicators that are predicted for a future resource based on the predicted interference on the future resource. For example, the one or more indicators may include one or more of: a CQI, a PMI, a RI, a CRI, a SSBRI, or a LI. In some implementations, the channel state feedback report is an aperiodic report triggered by the obtaining of the indication of predicted interference. In some implementations, the channel state feedback report includes a flag that indicates that the channel state feedback report is based on the predicted interference. Accordingly, the UE 104, the TX processor 368, or the controller/processor 359 executing the channel state feedback component 140 or the channel state reporting component 146 may provide means for outputting a channel state feedback report based at least in part on the indication.

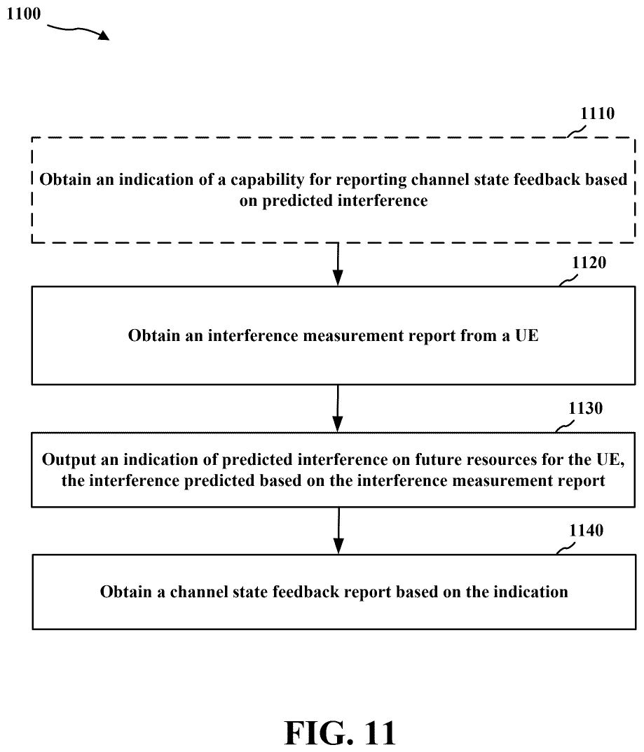

FIG. 11 is a flowchart of an example method 1100 for a wireless node such as a network entity to receive channel state feedback based on predicted interference. The method 1100 may be performed by a network entity 802 such as a base station (such as the base station 102, which may include the memory 376 and which may be the entire base station 102 or a component of the base station 102 such as the interference component 120, TX processor 316, RX processor 370, or the controller/processor 375). The method 1100 may be performed by the interference component 120 in communication with the channel state feedback component 140 at a UE. Optional blocks are shown with dashed lines.

At block 1110, the method 1100 may optionally include obtaining an indication of a capability for reporting channel state feedback based on predicted interference. In some implementations, for example, the network entity 802, the RX processor 370, or the controller/processor 375 may execute the interference component 120 or the configuration component 810 to obtain an indication of a capability 610 for reporting channel state feedback based on predicted interference. Accordingly, the network entity 802, the RX processor 370, or the controller/processor 375 executing the interference component 120 or the configuration component 810 may provide means for obtaining an indication of a capability for reporting channel state feedback based on predicted interference.

At block 1120, the method 1100 includes obtaining an interference measurement report from a UE. In some implementations, for example, the network entity 802, the RX processor 370, or the controller/processor 375 may execute the interference component 120 or the interference report receiving component 122 to obtain an interference measurement report from a UE. In some implementations, the interference measurement report includes a group of measurements and indicates: one or more measurement resources used to measure the group of measurements; or one or more timestamps for the measurements. Accordingly, the network entity 802, the RX processor 370, or the controller/processor 375 executing the interference component 120 or the interference report receiving component 122 may provide means for obtaining an interference measurement report from a UE.

At block 1130, the method 1100 includes outputting an indication of predicted interference on future resources for the UE, the interference predicted based on the interference measurement report. In some implementations, for example, the network entity 802, the TX processor 316, or the controller/processor 375 may execute the interference component 120 or the interference prediction component 124 to output an indication of predicted interference on future resources for the UE, the interference predicted based on the interference measurement report. In some implementations, the indication of predicted interference includes one or more of: a predicted interference power; a SINR; or a matrix Rₙₙ. In some implementations, the indication of predicted interference is associated with one or more transmit beams, one or more receive beams, or one or more combinations of a transmit beam and a receive beam. In some implementations, the indication of predicted interference includes a vector of predicted interference levels associated with multiple resources in a time domain or a frequency domain. In some implementations, the indication of predicted interference includes a confidence level of the prediction. Accordingly, the network entity 802, the TX processor 316, or the controller/processor 375 executing the interference component 120 or the interference prediction component 124 may provide means for outputting an indication of predicted interference on future resources for the UE, the interference predicted based on the interference measurement report.

At block 1140, the method 1100 includes obtaining a channel state feedback report based on the indication. In some implementations, for example, the network entity 802, the RX processor 370, or the controller/processor 375 may execute the interference component 120 or the interference report receiving component 122 to obtain the channel state feedback report 680 based on the indication. In some implementations, the channel state feedback report includes one or more indicators that are predicted for a future resource based on the predicted interference on the future resource. For example, the one or more indicators may include one or more of: a channel quality indicator (CQI), a precoding matrix indicator (PMI), a rank indicator (RI), a channel state information reference signal resource indicator (CRI), a synchronization signal block resource indicator (SSBRI), or a layer indicator (LI). In some implementations, the channel state feedback report is an aperiodic report triggered by the obtaining of the indication of predicted interference. In some implementations, the channel state feedback report includes a flag that indicates that the channel state feedback report is based on the predicted interference. Accordingly, the network entity 802, the RX processor 370, or the controller/processor 375 executing the interference component 120 or the CSF receiving component 126 may provide means for obtaining a channel state feedback report based on the indication.

In some cases, rather than actually transmitting a message, a device may have an interface to output a message for transmission (a means for outputting). For example, a processor may output a message, via a bus interface, to a radio frequency (RF) front end for transmission. Similarly, rather than actually receiving a message, a device may have an interface to obtain a message received from another device (a means for obtaining). For example, a processor may obtain (or receive) a message, via a bus interface, from an RF front end for reception. In some cases, the interface to output a message for transmission and the interface to obtain a message (which may be referred to as first and second interfaces herein) may be the same interface.

Means for obtaining and/or means for outputting may include any of the various processors and/or memories shown in FIG. 3. Means for receiving and/or means for transmitting may include any of the various processors, memories, and/or transceivers shown in FIG. 3.

The following numbered clauses provide an overview of aspects of the present disclosure:

Clause 1. A method of wireless communication at wireless node, comprising: outputting an interference measurement report; obtaining an indication of predicted interference on future resources, the interference predicted based on the interference measurement report; and outputting a channel state feedback report based at least in part on the indication of the predicted interference.

Clause 2. The method of clause 1, wherein the interference measurement report includes a configured group of measurements and indicates: one or more measurement resources used to measure the group of measurements; or one or more timestamps for the measurements.

Clause 3. The method of clause 1 or 2, wherein the indication of predicted interference includes one or more of: a predicted interference power; a signal to interference plus noise ratio (SINR); or an interference plus noise correlation matrix (Rnn).

Clause 4. The method of any of clauses 1-3, wherein the indication of predicted interference is associated with one or more transmit beams, one or more receive beams, or one or more combinations of one or more transmit beams and one or more receive beams.

Clause 5. The method of any of clauses 1-4, wherein the indication of predicted interference is a vector of predicted interference levels associated with multiple resources in a time domain or a frequency domain.

Clause 6. The method of any of clauses 1-5, wherein the indication of predicted interference includes a confidence level of the prediction.

Clause 7. The method of any of clauses 1-6, wherein the channel state feedback report includes one or more indicators that are predicted for a future resource based on the predicted interference on the future resource, the one or more indicators including one or more of: a channel quality indicator (CQI), a precoding matrix indicator (PMI), a rank indicator (RI), a channel state information reference signal resource indicator (CRI), a synchronization signal block resource indicator (SSBRI), or a layer indicator (LI).

Clause 8. The method of any of clauses 1-7, wherein the channel state feedback report is an aperiodic report triggered by the obtaining of the indication of predicted interference.

Clause 9. The method of any of clauses 1-8, wherein the channel state feedback report includes a flag that indicates that the channel state feedback report is based on the predicted interference.

Clause 10. The method of any of clauses 1-9, further comprising outputting an indication of a capability for reporting channel state feedback based on predicted interference, wherein the indication of predicted interference is in response to the indication of the capability.

Clause 11. An apparatus for wireless communication, comprising: one or more memories storing computer-executable instructions; and one or more processors coupled with the one or more memories and configured to execute the computer-executable instructions, individually or in combination, to cause the apparatus to perform a method in accordance with any one of clauses 1-10.

Clause 12: An apparatus, including means for performing a method in accordance with any one of clauses 1-10.

Clause 13: A non-transitory computer-readable medium including executable instructions that, when executed by a processor of an apparatus, cause the apparatus to perform a method in accordance with any one of clauses 1-10.

Clause 14: A computer program product embodied on a computer-readable storage medium including code for performing a method in accordance with any one of clauses 1-10.

Clause 15: A wireless node, including: at least one transceiver; one or more memories including instructions; and one or more processors configured to execute the instructions and cause the wireless node to perform a method in accordance with any one of clauses 1-10, wherein the at least one transceiver is configured to transmit the channel state feedback report.

Clause 16. A method for wireless communication, comprising: obtaining an interference measurement report from a user equipment (UE); outputting an indication of predicted interference on future resources, the interference predicted based on the interference measurement report; and obtaining a channel state feedback report based on the indication.

Clause 17. The method of clause 16, wherein the interference measurement report includes a group of measurements and indicates: one or more measurement resources used to measure the group of measurements; or one or more timestamps for the measurements.

Clause 18. The method of clause 16 or 17, wherein the indication of predicted interference includes one or more of: a predicted interference power; a signal to interference plus noise ratio (SINR); or an interference plus noise correlation matrix (Rnn).

Clause 19. The method of any of clauses 16-18, wherein the indication of predicted interference is for one or more transmit beams, one or more receive beams, or one or more combinations of one or more transmit beams and one or more receive beams.

Clause 20. The method of any of clauses 16-19, wherein the indication of predicted interference is a vector of predicted interference levels associated with multiple resources in a time domain or a frequency domain.

Clause 21. The method of any of clauses 16-20, wherein the indication of predicted interference includes a confidence level of the prediction.

Clause 22. The method of any of clauses 16-21, wherein the channel state feedback report includes one or more indicators that are predicted for a future resource based on the predicted interference on the future resource, the one or more indicators including one or more of: a channel quality indicator (CQI), a precoding matrix indicator (PMI), a rank indicator (RI), a channel state information reference signal resource indicator (CRI), a synchronization signal block resource indicator (SSBRI), or a layer indicator (LI).

Clause 23. The method of any of clauses 16-22, wherein the indication of predicted interference triggers the channel state feedback report as an aperiodic report.

Clause 24. The method of any of clauses 16-23, wherein the channel state feedback report includes a flag that indicates that the channel state feedback report is based on the predicted interference.

Clause 25. The method of any of clauses 16-24, wherein the one or more processors, individually or in combination, are configured to obtain an indication of a capability for reporting channel state feedback based on predicted interference, wherein the indication of predicted interference is in response to the indication of the capability.

Clause 26. An apparatus for wireless communication, comprising: one or more memories storing computer-executable instructions; and one or more processors coupled with the one or more memories and configured to execute the computer-executable instructions, individually or in combination, to cause the apparatus to perform a method in accordance with any one of clauses 16-25.

Clause 27: An apparatus, including means for performing a method in accordance with any one of clauses 16-25.

Clause 28: A non-transitory computer-readable medium including executable instructions that, when executed by a processor of an apparatus, cause the apparatus to perform a method in accordance with any one of clauses 16-25.

Clause 29: A computer program product embodied on a computer-readable storage medium including code for performing a method in accordance with any one of clauses 16-25.

Clause 30: A wireless node, including: at least one transceiver; one or more memories including instructions; and one or more processors configured to execute the instructions and cause the wireless node to perform a method in accordance with any one of clauses 16-25, wherein the at least one transceiver is configured to transmit the indication of predicted interference on future resources.

As used herein, a phrase referring to “at least one of” a list of items refers to any combination of those items, including single members. As an example, “at least one of: a, b, or c” is intended to cover: a, b, c, a-b, a-c, b-c, and a-b-c. Similarly, as used herein, a phrase referring to “one or more of” a list of items refers to any combination of those items, including single members. As an example, “one or more of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An apparatus for wireless communication, comprising:
one or more memories storing computer-executable instructions; and
one or more processors configured to execute the computer-executable instructions, individually or in combination, to cause the apparatus to:
output an interference measurement report for a user equipment (UE);
obtain an indication of predicted interference on future resources, the interference predicted based on the interference measurement report; and
output a channel state feedback report based at least in part on the indication.

2. The apparatus of claim 1, wherein the interference measurement report includes a group of measurements and indicates:
one or more measurement resources used to measure the group of measurements; or
one or more timestamps for the measurements.

3. The apparatus of claim 1, wherein the indication of predicted interference includes one or more of:
a predicted interference power;
a signal to interference plus noise ratio (SINR); or
an interference plus noise correlation matrix (Rₙₙ).

4. The apparatus of claim 1, wherein the indication of predicted interference is associated with one or more transmit beams, one or more receive beams, or one or more combinations of one or more transmit beams and one or more receive beams.

5. The apparatus of claim 1, wherein the indication of predicted interference includes a vector of predicted interference levels associated with multiple resources in a time domain or a frequency domain.

6. The apparatus of claim 1, wherein the indication of predicted interference includes a confidence level of the prediction.

7. The apparatus of claim 1, wherein the channel state feedback report includes one or more indicators that are predicted for a future resource based on the predicted interference on the future resource, the one or more indicators including one or more of:
a channel quality indicator (CQI),
a precoding matrix indicator (PMI),
a rank indicator (RI),
a channel state information reference signal resource indicator (CRI),
a synchronization signal block resource indicator (SSBRI), or
a layer indicator (LI).

8. The apparatus of claim 1, wherein the channel state feedback report is an aperiodic report triggered by the obtaining of the indication of predicted interference.

9. The apparatus of claim 1, wherein the channel state feedback report includes a flag that indicates that the channel state feedback report is based on the predicted interference.

10. The apparatus of claim 1, wherein the one or more processors, individually or in combination, are configured to output an indication of a capability for reporting channel state feedback based on predicted interference, wherein the indication of predicted interference is in response to the indication of the capability.

11. The apparatus of claim 1, further comprising a transceiver configured to transmit the interference measurement report and the channel state feedback report, wherein the apparatus is configured as a user equipment.

12. An apparatus for wireless communication, comprising:
one or more memories storing computer-executable instructions; and
one or more processors configured to execute the computer-executable instructions, individually or in combination, to cause the apparatus to:
obtain an interference measurement report from a user equipment (UE);
output an indication of predicted interference on future resources, the interference predicted based on the interference measurement report; and
obtain a channel state feedback report based on the indication.

13. The apparatus of claim 12, wherein the interference measurement report includes a group of measurements and indicates:
one or more measurement resources used to measure the group of measurements; or
one or more timestamps for the measurements.

14. The apparatus of claim 12, wherein the indication of predicted interference includes one or more of:
a predicted interference power;
a signal to interference plus noise ratio (SINR); or
an interference plus noise correlation matrix (Rₙₙ).

15. The apparatus of claim 12, wherein the indication of predicted interference is for one or more transmit beams, one or more receive beams, or one or more combinations of one or more transmit beams and one or more receive beams.

16. The apparatus of claim 12, wherein the indication of predicted interference is a vector of predicted interference levels associated with multiple resources in a time domain or a frequency domain.

17. The apparatus of claim 12, wherein the indication of predicted interference includes a confidence level of the prediction.

18. The apparatus of claim 12, wherein the channel state feedback report includes one or more indicators that are predicted for a future resource based on the predicted interference on the future resource, the one or more indicators including one or more of:
a channel quality indicator (CQI),
a precoding matrix indicator (PMI),
a rank indicator (RI),
a channel state information reference signal resource indicator (CRI),
a synchronization signal block resource indicator (SSBRI), or
a layer indicator (LI).

19. The apparatus of claim 12, wherein the indication of predicted interference triggers the channel state feedback report as an aperiodic report.

20. The apparatus of claim 12, wherein the channel state feedback report includes a flag that indicates that the channel state feedback report is based on the predicted interference.

21. The apparatus of claim 12, wherein the one or more processors, individually or in combination, are configured to obtain an indication of a capability for reporting channel state feedback based on predicted interference, wherein the indication of predicted interference is in response to the indication of the capability.

22. The apparatus of claim 12, further comprising a transceiver configured to transmit the indication of predicted interference, wherein the apparatus is configured as a network entity.

23. A method of wireless communication at a wireless node, comprising:
outputting an interference measurement report;
obtaining an indication of predicted interference on future resources, the interference predicted based on the interference measurement report; and
outputting a channel state feedback report based at least in part on the indication of the predicted interference.
